(19) United States
(12) Patent Application Publication
(10) Pub. No.: US 2011/0160985 A1
(43) Pub. Date: Jun. 30, 2011

(54) IN-VEHICLE CONTROL APPARATUS

(75) Inventor: Kazuhi YAMAGUCHI, Kobe-shi (JP)

(73) Assignee: FUJITSU TEN LIMITED, KOBE-SHI (JP)

(21) Appl. No.: 12/966,479

(22) Filed: Dec. 13, 2010

(30) Foreign Application Priority Data
Dec. 24, 2009 (JP) 2009-293403

(51) Int. Cl. F02D 28/00

(52) U.S. Cl. 701/112

(57) ABSTRACT

An in-vehicle control apparatus includes: a first controlling part that controls a controlled object by using data stored in a volatile memory part; and a second controlling part that transmits an abnormality notice signal to the first controlling part when an abnormality occurs in the vehicle. The first controlling part identifies: the type of the abnormality occurring as a first abnormality when the abnormality notice signal represents the first abnormality and the data stored in the volatile memory part is initialized; the type of the abnormality occurring as a second abnormality when the abnormality notice signal represents an abnormality other than the first abnormality and the data stored in the volatile memory part is initialized; and the type of the abnormality occurring as a third abnormality when the abnormality notice signal represents the third abnormality.

### BACKGROUND OF THE INVENTION

1. Field of the Invention

The invention relates to a technology that controls a controlled object for installation in a vehicle.

2. Description of the Background Art

Recently, a CPU in a microcomputer or the like installed in an in-vehicle control apparatus controls a controlled object installed in the vehicle, by running a control program stored in a memory part, e.g., ROM.

The CPU installed in the in-vehicle control apparatus sometimes stops the control of the controlled object due to various factors, and the user of the vehicle desires to know the reason for the stop of the control. Therefore, the in-vehicle control apparatus is set to notify the user of the factor for the stop of the control by recording it in the memory part and displaying it on a display.

Among such technologies, a widely known technology, for example, is the one that notifies a user of a reason for stopping an idling stop control under which an in-vehicle control apparatus stops the engine of the vehicle in a case where a predetermined condition is satisfied.

However, there may be a case where the in-vehicle control apparatus stops controlling the controlled object due to some different factors of the stop of the control which occur substantially simultaneously. In such a case, the CPU in the in-vehicle control apparatus may not appropriately identify and record the factors.

### SUMMARY OF THE INVENTION

According to one aspect of this invention, an in-vehicle control apparatus for controlling a controlled object for installation in a vehicle includes: a first controlling part that controls the controlled object by using data stored in a volatile memory part; and a second controlling part that transmits an abnormality notice signal to the first controlling part when an abnormality occurs in the vehicle. The second controlling part includes: a first determination part that determines an occurrence of a first abnormality relating to behavior of the first controlling part; a second determination part that determines an occurrence of a second abnormality relating to electric power supplied to the first controlling part; a third determination part that determines an occurrence of a third abnormality relating to a predetermined element included in the vehicle; a transmission part that transmits an initialization signal for initializing the data stored in the volatile memory part to the first controlling part when one of the first abnormality and the second abnormality occurs; and a communication part that transmits the abnormality notice signal having a waveform pattern that represents the type of an abnormality occurring to the first controlling part via a communication line. The communication part transmits the abnormality notice signal representing the third abnormality to the first controlling part when the third abnormality occurs substantially simultaneously with another abnormality. The first controlling part includes: an identification part that identifies the type of the abnormality occurring on the basis of the abnormality notice signal; a recording part that records the type of the abnormality occurring on a nonvolatile recording apparatus; and an identification prohibiting part that prohibits identification implemented by the identification part when the abnormality notice signal represents the third abnormality and the data stored in the volatile memory part is initialized. The identification part identifies: the type of the abnormality occurring as the first abnormality when the abnormality notice signal represents the first abnormality and the data stored in the volatile memory part is initialized; the type of the abnormality occurring as the second abnormality when the abnormality notice signal represents an abnormality other than the first abnormality and the data stored in the volatile memory part is initialized; and the type of the abnormality occurring as the third abnormality when the abnormality notice signal represents the third abnormality.

The in-vehicle control apparatus is capable of avoiding misidentification of the type of an abnormality by prohibiting the identification when the third abnormality occurs substantially simultaneously with another abnormality and the another abnormality cannot be identified.

According to another aspect of this invention, the controlled object is an engine, and the first controlling part performs an idling stop control that stops the engine when a predetermined condition is satisfied.

While performing the idling stop control, the in-vehicle control apparatus is capable of avoiding misidentification of the type of an abnormality by prohibiting the identification when the third abnormality occurs substantially simultaneously with another abnormality and the another abnormality cannot be identified.

According to another aspect of this invention, the in-vehicle control apparatus further includes a control prohibiting part that prohibits the idling stop control when the identification part identifies the part of the abnormality occurring as one of the first abnormality, the second abnormality and the third abnormality.

When the identification part included in the in-vehicle control apparatus identifies the type of the abnormality occurring as one of the first abnormality, the second abnormality and the third abnormality, the control prohibiting part prohibits the idling stop control so that an unforeseen contingency in a vehicle control can be avoided.

Therefore, an object of the invention is to provide a technology that appropriately identifies and records the type of an abnormality which has occurred in a vehicle, in an in-vehicle control apparatus.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a control system in a vehicle;

FIG. 2 is a block diagram showing a system of an idling stop control apparatus;

FIG. 3 is a diagram explaining factors of an engine stall;

FIG. 4 is a timing diagram of a vehicle control;

FIG. 5 is a timing diagram of a vehicle control;

FIG. 6 is a timing diagram of a vehicle control;

FIG. 7 is a timing diagram of a vehicle control;

FIG. 8 is a timing diagram of a vehicle control;

FIG. 9 is a timing diagram of a vehicle control; and

FIG. 10 is a timing diagram of a vehicle control.

### DESCRIPTION OF THE EMBODIMENTS

Hereinbelow, an embodiment of the invention is described with reference to the drawings.

### Exemplary Embodiment

### Vehicle Control System

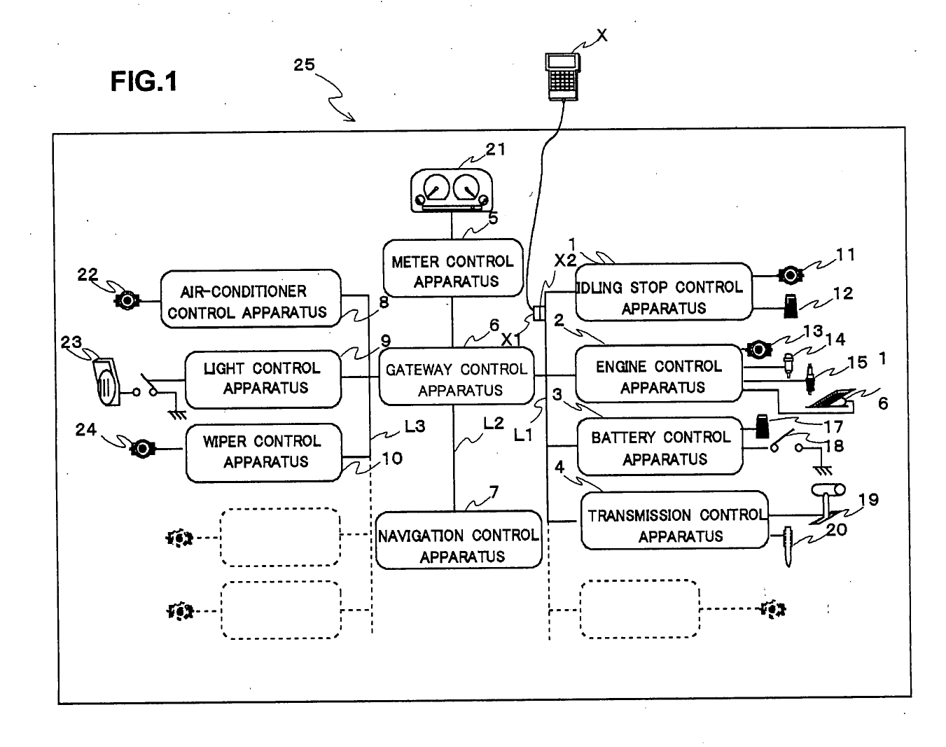

FIG. 1 shows a control system of a vehicle 25 in an exemplary embodiment. In a control system of the vehicle 25, a plurality of in-vehicle control apparatuses are connected to an in-vehicle network L, such as a network called CAN (Controller Area Network). Each of the plurality of in-vehicle control apparatuses is connected to one or more in-vehicle controlled objects, to control. These in-vehicle control apparatuses are called ECU (Electronic Control Unit), for example.

A gateway control apparatus 6 among the plurality of in-vehicle control apparatuses is designed to relay a plurality of in-vehicle networks and to control traffic of data transmitted among the plurality of in-vehicle networks. Examples of the plurality of in-vehicle networks include a power-related network L1, to which an in-vehicle control apparatus related to running of the vehicle 25 is connected, an information-related network L2, to which an in-vehicle control apparatus related to information provision is connected, and a body-related network L3, to which an in-vehicle control apparatus related to an electric component is connected. A meter control apparatus 5 is directly connected to the gateway control apparatus 6.

Some of the in-vehicle control apparatuses such as an idling stop control apparatus 1, an engine control apparatus 2, a battery control apparatus 3, and a transmission control apparatus 4 are connected to the power-related network L1.

Each of the in-vehicle control apparatuses includes an arithmetic processing part (e.g., UPC), and, mainly, the arithmetic processing part works with various electronic parts to control the controlled object.

Based on a value input mainly from an engine revolution sensor 12 and the like, the arithmetic processing part included in the idling stop control apparatus 1 controls a starter motor 11 that is one of the in-vehicle controlled objects and that assists a rotating force of the engine to perform a cranking control of the vehicle 25. Based on a value input mainly from an accelerator sensor 16 and the like, the arithmetic processing part included in the engine control apparatus 2 controls a throttle motor 13, an injector 14, and a sparking plug 15 that control the torque of the engine. Based on a value input mainly from a battery power voltage sensor 17 and the like, an arithmetic processing part included in the battery control apparatus 3 controls a switch 18 that is one of the controlled objects and that charges and discharges electricity. Based on a value input mainly from a shift step sensor 19 connected to a shift lever of the vehicle 25, an arithmetic processing part included in the transmission control apparatus 4 controls a solenoid 20 that is one of the controlled objects and that changes a shift step of the shift lever.

A navigation control apparatus 7 and the like are connected to the information-related network L2.

An arithmetic processing part included in the navigation control apparatus 7 controls display of position data mainly received from a GPS satellite and of map data stored in a memory part on a display that is one of the controlled objects.

An air-conditioner control apparatus 8, a light control apparatus 9, a wiper control apparatus 10 and the like are connected to the body-related network L3.

Based on a value input mainly from a temperature sensor and the like, an arithmetic processing part included in the air-conditioner control apparatus 8 controls a motor 22 that is one of the controlled objects and that modulates an air condition in a cabin of the vehicle 25. Based on a signal representing that a light of the vehicle 25 is turned on mainly by a user operation, an arithmetic processing part included in the light control apparatus 9 controls a lighting of headlights 23 and the like that are among the controlled objects. Based on a signal representing that wipers of the vehicle 25 are turned on mainly by a user operation, an arithmetic processing part included in the wiper control apparatus 10 controls a wiper motor 24 that is one of the controlled objects.

Based on an input value mainly from each of the in-vehicle control apparatuses and various sensors, an arithmetic processing part included in the meter control apparatus 5 directly connected to the gateway control apparatus 6 controls an instrument panel 21 including a speed meter, an engine revolution meter, etc. that are among the controlled objects.

A connector X1 of a cable extending from an external apparatus X is connected to, e.g., a connector X2 on an in-vehicle network side of the power-related network L1. The external apparatus X receives a user operation and causes the in-vehicle control apparatuses connected to the in-vehicle network L to implement a control in accordance with the user operation. Concretely, the external apparatus X has a function to read out information stored in the memory part of the idling stop control apparatus 1 and the like, via the in-vehicle network L, and to cause the information read out to be displayed on a display of the external apparatus X.

(In-Vehicle Control Apparatus)

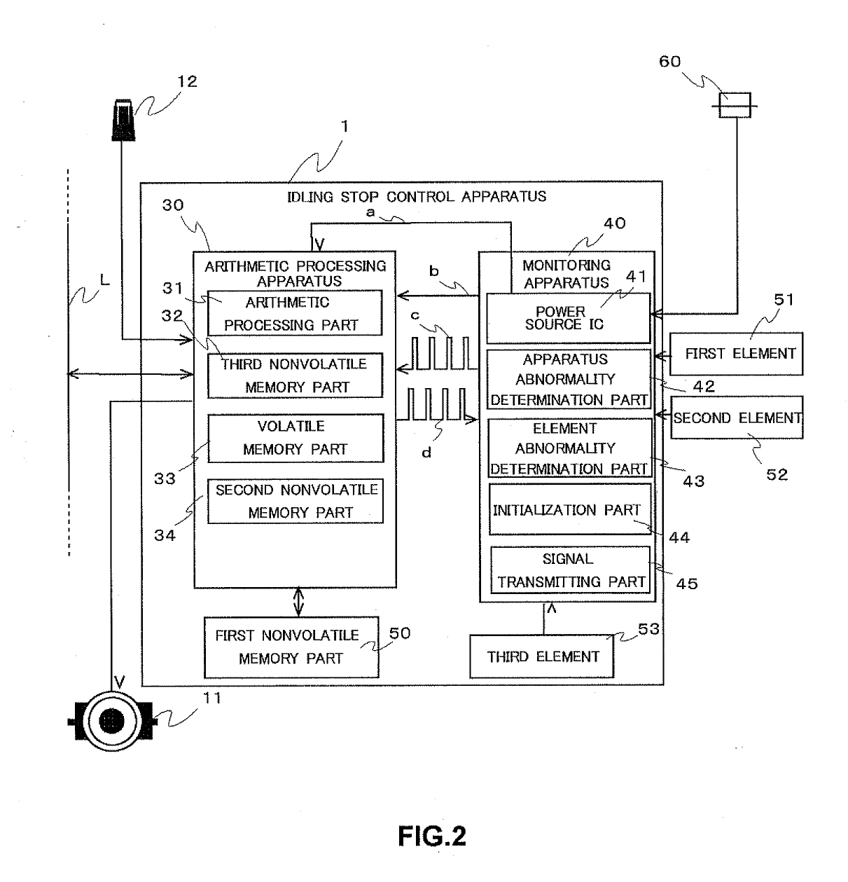

The idling stop control apparatus 1 is explained with reference to FIG. 2.

The idling stop control apparatus 1 includes an arithmetic processing apparatus 30 (e.g., a microcomputer) as a first controlling part that mainly performs an idling stop function, a recording apparatus or a first nonvolatile memory part 50 (e.g., an EEPROM) that is capable of writing and reading out data such as data relating to an abnormality, and a monitoring apparatus 40 as a second controlling part that determines an occurrence of an abnormality and informs the arithmetic processing apparatus 30 of the abnormality.

The arithmetic processing apparatus 30 includes a second nonvolatile memory part 34 (e.g., a ROM) that is nonvolatile and in which a control program for the idling stop function is stored, a volatile memory part 33 (e.g., a NRAM) that is volatile and capable of writing and reading out data used for an arithmetic processing performed by an arithmetic processing part 31 (e.g., a CPU), and a third nonvolatile memory part 32 (e.g., a SRAM) that is nonvolatile and capable of writing and reading out backup data of the data written in the first nonvolatile memory part 50 and is directly supplied with power from a power source 60 (e.g., a battery).

The arithmetic processing part 31 controls driving of the starter motor 11 based on the control program stored in the second nonvolatile memory part 34, on the data stored in the volatile memory part 33, and input signals such as from the engine revolution sensor 12, the in-vehicle network L.

The idling stop control apparatus 1 performs the idling stop function by the supply of the power from a first power line led from the power source 60. The first power line supplies the power to the in-vehicle control apparatuses such as the idling stop control apparatus 1 when the control system of the vehicle 25 is activated by a user operation of a user switch, e.g., an ignition switch and a push start switch. On the other hand, a second power line supplies the power constantly to the third nonvolatile memory part 32, regardless of presence of the user operation of the user switch.

(Arithmetic Processing Apparatus)

A control implemented by the arithmetic processing apparatus 30 is described below. The arithmetic processing part 31 of the arithmetic processing apparatus 30 performs mainly an idling stop control. The arithmetic processing part 31 performs a fail-safe control, an abnormality identification control and an abnormality record control.

(Idling Stop Control)

The idling stop control means a control of an engine to reduce fuel consumption. During a time period from when the engine is started by an operation made with the user switch until the engine is stopped by another operation made with the user switch, under the idling stop control, the engine is stopped when a condition, such as a stop of the vehicle 25 having a vehicle speed of zero, is satisfied, and the engine is restarted when a condition, such as detection of a user operation subsequently made with an accelerator of the vehicle 25, is satisfied. The idling stop control is performed by the arithmetic processing part 31 of the idling stop control apparatus 1 by working with another electronic part and/or a control element such as the engine control apparatus 2.

(Fail-Safe Control)

The fail-safe control means a control implemented by the arithmetic processing part 31 to avoid an inconvenience caused by a particular abnormality. For example, the arithmetic processing part 31 implements the control to avoid the inconvenience in a case where an abnormality in behavior of itself, or in other words, a runaway process abnormality, which is a first abnormality, has occurred. In addition, the arithmetic processing part 31 implements the control to avoid an inconvenience in a case where an abnormality in the power supply, or in other words, a reduced-voltage abnormality, which is a second abnormality, has occurred. The reduced-voltage abnormality means a voltage reduction to a level at which the voltage cannot ensure a predetermined voltage value (e.g., 5 V) required to run the arithmetic processing part 31. Moreover, the arithmetic processing part 31 implements the control to avoid an inconvenience in a case where the monitoring apparatus 40 determines that a third abnormality has occurred. The third abnormality or in other words, an abnormality in a predetermined element, is an abnormality that has occurred in one of a plurality of the predetermined elements (e.g., a first element 51, a second element 52, and a third element 53 included in the vehicle 25).

An apparatus abnormality determination part 42 included in the monitoring apparatus 40 determines whether the runaway process abnormality has occurred in the arithmetic processing part 31. When the apparatus abnormality determination part 42 determines an occurrence of the runaway process abnormality, the arithmetic processing part 31 receives a reset (initialization) signal sent from an initialization part 44 included in the monitoring apparatus 40 and initializes the behavior of itself.

A control process from determining the occurrence of the runaway process abnormality to the initialization is concretely explained. The arithmetic processing apparatus 30 is electrically connected to the monitoring apparatus 40 by communication lines b, c, and d. The arithmetic processing part 31 included in the arithmetic processing apparatus 30 transmits a watchdog timer signal to the monitoring apparatus 40 via the communication line d. When the watchdog timer signal is not a pulse signal of a predetermined cycle, the apparatus abnormality determination part 42 determines that the arithmetic processing part 31 is in a runaway state, and the initialization part 44 transmits the initialization signal to the arithmetic processing apparatus 30 via the communication line b. The arithmetic processing part 31 included in the arithmetic processing apparatus 30 receives the initialization signal via the communication line b and then resets the behavior of itself. In other words, the arithmetic processing part 31 performs the idling stop control from an initialized state and initializes the data stored in the volatile memory part 33 and used by the arithmetic processing part 31 for the arithmetic processing. For example, the arithmetic processing part 31 initializes a parameter stored in the volatile memory part 33 and used for arithmetic processing performed by the arithmetic processing part 31. Moreover, the arithmetic processing part 31 writes an initial value and a learning value being read out from the third nonvolatile memory part 32 or the first nonvolatile memory part 50 into the volatile memory part 33.

A power source IC 41 included in the monitoring apparatus 40 determines whether the reduced-voltage abnormality that requires initialization of the arithmetic processing part 31 has occurred. When the power source IC 41 determines the occurrence of the reduced-voltage abnormality, the arithmetic processing part 31 receives the initialization signal transmitted from the initialization part 44 and initializes the behavior of itself.

A control process from determining the occurrence of the reduced-voltage abnormality to the initialization is concretely described. The power source IC 41 controls and monitors a voltage of the power supplied from the power source 60. While converting a voltage of the power supplied from the power source 60 to the predetermined voltage value required to run the arithmetic processing part 31, the power source IC 41 determines whether or not the voltage value of the power supplied from the power source 60 to the arithmetic processing part 31 by way of the power source IC 41 (via a power line a) is equal to or lower than the predetermined voltage value (or determines the reduced-voltage abnormality). The monitoring apparatus 40 transmits the initialization signal to the arithmetic processing apparatus 30 via the communication line b when the power source IC 41 included in the monitoring apparatus 40 determines the reduced-voltage abnormality. The arithmetic processing part 31 included in the arithmetic processing apparatus 30 receives the initialization signal via the communication line b and initializes the behavior of itself.

An element abnormality determination part 43 included in the monitoring apparatus 40 determines an occurrence of the abnormality in a predetermined element. The arithmetic processing part 31 identifies a type in which an abnormality is categorized (hereinafter referred to as abnormality type), based on the pulse signal representing the duty cycle. The pulse signal is transmitted from a signal transmitting part 45 included in the monitoring apparatus 40 via the communication line c. The pulse signal is an abnormality notice signal having a waveform pattern that represents a type of an abnormality that has occurred. After identifying the abnormality type based on the pulse signal, the arithmetic processing part 31 performs the fail-safe control in accordance with the abnormality type. A detailed process of identifying the abnormality type is explained later.

(Abnormality Identification Control)

The abnormality identification control means a control that the arithmetic processing part 31 included in the arithmetic processing apparatus 30 identifies the abnormality type based on the pulse signal transmitted by the signal transmitting part 45 via the communication line c. when the monitoring apparatus 40 determines that the abnormality has occurred.

The arithmetic processing part 31 identifies the abnormality type of an abnormality determined by the monitoring apparatus 40, based on the duty cycle of the pulse signal received from the communication line c. Abnormality types are, as mentioned above, the runaway process abnormality of the arithmetic processing part 31, the reduced-voltage abnormality requiring the initialization of the arithmetic processing part 31, and the abnormality in a predetermined element (the first element 51, the second element 52, or the third element 53). Examples of the predetermined elements 51, 52 and 53 include a current sensor included in hardware controlled by the idling stop control apparatus 1 and an electronic part working with the arithmetic processing part 31 of the idling stop control apparatus 1 when the arithmetic processing part 31 performs the idling stop control.

Fewer communication lines for transmitting the abnormality type from the monitoring apparatus 40 to the arithmetic processing part 31 are more desirable in terms of cost, control load, etc. Therefore, the communication line is configured by one communication line c.

Since the arithmetic processing part 31 identifies the abnormality type based on the signal transmitted only from the communication line c, the duty cycle of the pulse signal transmitted differs according to the abnormality type. For example, a duty cycle in a pattern A represents no-abnormality, a duty cycle in a pattern B represents the runaway process abnormality, and a duty cycle in a pattern other than the pattern A and the pattern B represents the reduced-voltage abnormality. Based on this, the arithmetic processing part 31 can identify no-abnormality when receiving the duty cycle of the pulse signal in the pattern A from the communication line c. The arithmetic processing part 31 identifies the runaway process abnormality, which requires the initialization of the arithmetic processing part 31, when the arithmetic processing part 31 receives the duty cycle of the pulse signal in the pattern B and also the parameter stored in the volatile memory part 33 has been initialized. The arithmetic processing part 31 identifies the reduced-voltage abnormality, which requires the initialization of the arithmetic processing part 31, when the arithmetic processing part 31 receives the duty cycle of the pulse signal in a pattern other than the pattern A and the pattern B and also the parameter stored in the volatile memory part 33 has been initialized.

In other words, when an abnormality has occurred in the arithmetic processing part 31, the parameter of the volatile memory part 33 is initialized based on the initialization signal from the monitoring apparatus 40. Therefore, the initialization of the arithmetic processing part 31 by the monitoring apparatus 40 allows determining the occurrence of the abnormality that requires the initialization of the arithmetic processing part 31 and identifying an abnormality type of the abnormality in the arithmetic processing part 31 based on the duty cycle of the signal.

In order to identify the abnormality type based on the duty cycle of the signal from the communication line c, for example, it is set in advance that a duty cycle in a pattern C represents an abnormality in the first element 51, a duty cycle in a pattern D represents an abnormality in the second element 52, and a duty cycle in a pattern E represents an abnormality in the third element 53. Based on this, the arithmetic processing part 31 can identify the abnormality in the first element 51 when receiving the duty cycle of the pulse signal in the pattern C, the abnormality in the second element 52 when receiving the duty cycle of the pulse signal in the pattern D, and the abnormality of the third element 53 when receiving the duty cycle of the pulse signal received in the pattern E, respectively, from the communication line c.

In other words, the abnormality type of an abnormality occurring in each of the predetermined elements can be identified based on the duty cycle of the pulse signal that the arithmetic processing part 31 receives from the monitoring apparatus 40 via the communication line c.

(Simultaneous Occurrences of Multiple Abnormalities)

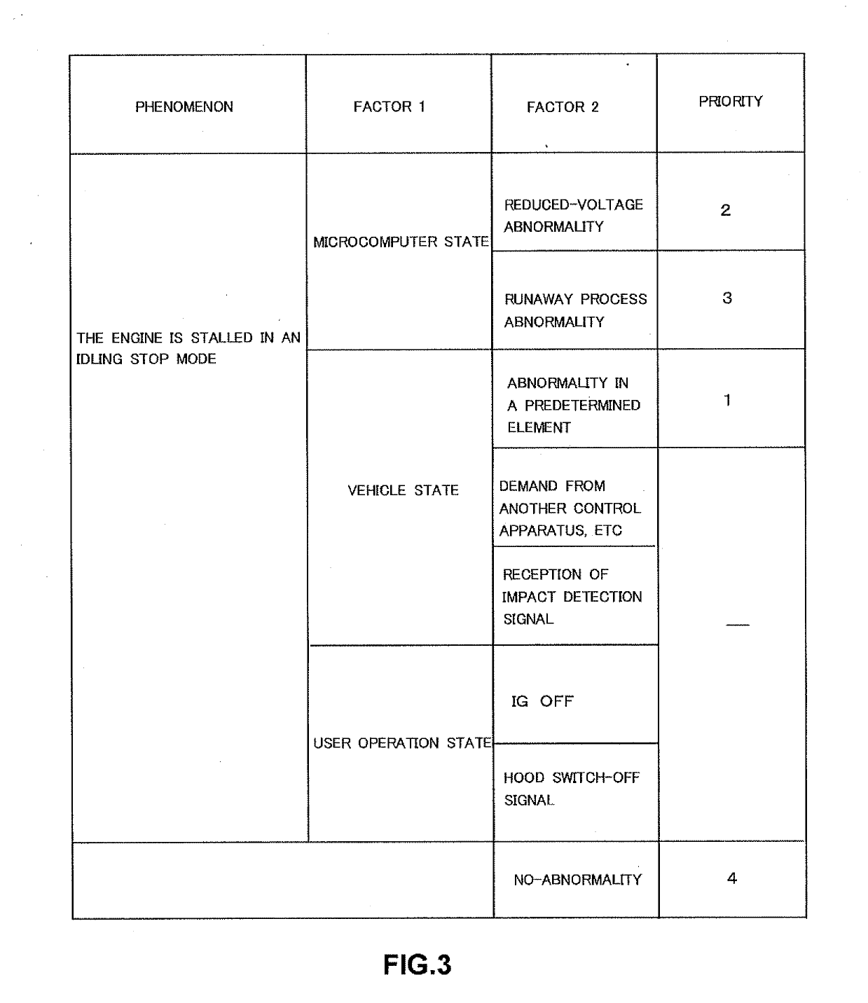

When determining that plural abnormalities have occurred substantially simultaneously, the monitoring apparatus 40 notifies the arithmetic processing apparatus 30 of an abnormality having a higher priority of, notification, via the communication line c. The priority is established as shown in FIG. 3. The abnormality in a predetermined element, of which notification is required most, is set as the first priority. The reduced-voltage abnormality is set as the second, the runaway process abnormality is set as the third, and a state of no-abnormality having the least necessity for notification is set as the fourth priority.

When substantially simultaneously determining occurrences of the abnormality in a predetermined element and the reduced-voltage abnormality, the monitoring apparatus 40 transmits the pulse signal of the duty cycle representing the abnormality in a predetermined element, in priority to the reduced-voltage abnormality, to the arithmetic processing apparatus 30 via the communication line c. This means that the monitoring apparatus 40 prioritizes the abnormality having a higher priority of notification to the arithmetic processing apparatus 30.

When the monitoring apparatus 40 determines an occurrence of the runaway process abnormality or the reduced-voltage abnormality in the arithmetic processing part 31, the arithmetic processing apparatus 30 can receive the initialization signal from the monitoring apparatus 40 via the communication line b that is different from the communication line c, and the arithmetic processing apparatus 30 can initialize itself (perform the fail-safe control). However, the fail-safe control for the abnormality in a predetermined element is implemented after the abnormality is identified based on the pulse signal received from the communication line c. Therefore, the abnormality in a predetermined element has a higher priority of notification than the other abnormalities.

However, there may be an inconvenience when the abnormality in a predetermined element occurs substantially simultaneously with the runaway process abnormality or the reduced-voltage abnormality. In other words, in such a situation, the arithmetic processing part 31 identifies the abnormality in a predetermined element because a pattern of the duty cycle of the pulse signal received from the communication line c is the pattern (in one of the pattern C, the pattern D and the pattern E) representing the abnormality in a predetermined element and the parameter stored in the volatile memory part 33 has been initialized. At the same time, the arithmetic processing part 31 also determines the other abnormality as the reduced-voltage abnormality although the arithmetic processing part 31 cannot identify whether the other abnormality is the runaway process abnormality or the reduced-voltage abnormality. The arithmetic processing part 31, as mentioned earlier, identifies the abnormality in a predetermined element because the arithmetic processing part 31 receives the duty cycle of the pulse signal representing the abnormality in a predetermined element from the communication line c. However, the pattern C, the pattern D, or the pattern E is a pattern other than the pattern A and the pattern B, and the parameter stored in the volatile memory part 33 has been initialized. As a result, the arithmetic processing part 31 identified the other abnormality as the reduced-voltage abnormality. If the runaway process abnormality occurs substantially simultaneously with the abnormality in a predetermined element, the arithmetic processing part 31 may misidentify the occurrence of the runaway process abnormality as an occurrence of the reduced-voltage abnormality, and then wrong information may be recorded in a process of the abnormality record control, which will be described later.

Therefore, in a case where the arithmetic processing part 31 receives the duty cycle of the pulse signal from the communication line c in the pattern (in one of the pattern C, the pattern D, and the pattern E) representing the abnormality in a predetermined element and the parameter stored in the volatile memory part 33 has been initialized, the arithmetic processing part 31 prohibits identification of the reduced-voltage abnormality. As a result, the arithmetic processing apparatus 30 can avoid an inconvenience that wrong information caused by the misidentification is recorded.

(Abnormality Record Control)

The arithmetic processing part 31 records the abnormality type identified by implementing the abnormality identification control, into the first nonvolatile memory part 50 which is a nonvolatile memory apparatus. That allows the arithmetic processing part 31 to record a factor in a fail-safe control, e.g., prohibition of the idling stop control, implemented after the occurrence of the abnormality. Moreover, an abnormality content stored in the first nonvolatile memory part 50 can be read by using the external apparatus X (e.g., an external tool), and can be displayed on the display of the external apparatus X. As a result, the user can know the factor in the prohibition of the idling stop control. A nonvolatile memory apparatus is suited for a memory part to which the abnormality content is written. Therefore, the abnormality content may be written to the third nonvolatile memory part 32.

In order to record the abnormality content, factor counters of the runaway process abnormality, of the reduced-voltage abnormality, of the abnormality in a predetermined element, and user operation are set in the first nonvolatile memory part 50 included in the idling stop control apparatus 1. Each time when identifying an abnormality, the arithmetic processing part 31 advances the factor counter corresponding to the abnormality to count. Moreover, the factor counter of the abnormality in a predetermined element may be set for each of the first element 51, the second element 52, and the third element 53 in order to count an abnormality that occurs in each of the predetermined elements. The factor counters allow the arithmetic processing part 31 to record both factors and frequencies of abnormalities that have occurred individually in the predetermined elements.

On the other hand, the arithmetic processing part 31 prohibits the idling stop control due to a factor other than the abnormalities determined by the monitoring apparatus 40. The following, as shown in FIG. 3, are examples of such a factor.

The idling stop control is prohibited due to a factor related to a vehicle state. For example, the idling stop control is prohibited when the arithmetic processing part 31 receives a command to prohibit the idling stop control from one of the other in-vehicle control apparatuses. In addition, the idling stop control is prohibited when the arithmetic processing apparatus 30 receives an impact detection signal representing that the vehicle 25 collides against an external object.

The idling stop control is also prohibited due to a factor related to a user operation state. For example, the idling stop control is prohibited when the arithmetic processing apparatus 30 receives a user switch-off signal. In addition, idling stop control is prohibited when the arithmetic processing apparatus 30 receives a hood switch-off signal.

The arithmetic processing apparatus 30 avoids an unforeseen contingency by prohibiting the idling stop control when one of the factors mentioned above occurs.

(Notification Control)

When prohibiting the idling stop control, the arithmetic processing part 31 implements a notification control for notifying the user of the prohibition by outputting information that the idling stop control is prohibited, to a notification apparatus which is not illustrated in the drawings.

Concretely, when prohibiting the idling stop control, the arithmetic processing part 31 outputs information that the idling stop control is prohibited and causes the information to be displayed on an in-vehicle liquid crystal screen.

As a result, the user knows a reason why the idling stop function is not being performed in the vehicle 25.

(Monitoring Apparatus)

A control implemented by the monitoring apparatus 40 is described. The monitoring apparatus 40 implements a control for determining the runaway process abnormality of the first abnormality as well as the reduced-voltage abnormality of the second abnormality, and the abnormality in a predetermined element of the third abnormality. Moreover, the monitoring apparatus 40 implements a control for transmitting the abnormality notice signal.

(Control for Determining Runaway Process Abnormality)

The control for determining the runaway process abnormality, as mentioned above, means a control under which the monitoring apparatus 40 monitors (determines) an abnormality in the arithmetic processing apparatus 30. When determining an occurrence of the runaway process abnormality, the monitoring apparatus 40 transmits to the arithmetic processing part 31 the initialization signal for initializing the behavior of the arithmetic processing part 31, and the behavior of the arithmetic processing apparatus 30 is initialized.

The control process from the determination of an occurrence of the runaway process abnormality to the initialization is concretely described from an aspect of the monitoring apparatus 40. The monitoring apparatus 40 is electrically connected to the arithmetic processing apparatus 30 by the communication lines b, c, and d. The monitoring apparatus 40 receives the watchdog timer signal from the arithmetic processing part 31 included in the arithmetic processing apparatus 30 via the communication line d. When the watchdog timer signal received via the communication line d is not the pulse signal of the predetermined cycle, the monitoring apparatus 40 determines that the arithmetic processing part 31 is in a runaway state, and transmits the initialization signal to the arithmetic processing apparatus 30 via the communication line b. The arithmetic processing part 31 included in the arithmetic processing apparatus 30 receives the initialization signal via the communication line b and then initializes the behavior of itself.

(Control for Determining Reduced-Voltage Abnormality)

The control for determining the reduced-voltage abnormality means a control under which the monitoring apparatus 40 monitors (determines) an abnormality in the arithmetic processing apparatus 30. When determining an occurrence of the reduced-voltage abnormality, the monitoring apparatus 40 transmits the initialization signal to the arithmetic processing apparatus 30 and the behavior of the arithmetic processing apparatus 30 is initialized.

A control process from the determination of the occurrence of the reduced-voltage abnormality to the initialization is concretely described from an aspect of the monitoring apparatus 40. The monitoring apparatus 40 includes the power source IC 41 that controls and monitors a voltage of the power supplied from the power source 60. While converting the power supplied from the power source 60 to the predetermined voltage value required to run the arithmetic processing part 31, the power source IC 41 determines whether or not the voltage value of the power supplied from the power source 60 to the arithmetic processing part 31 by way of the power source IC 41 (via the power line a) is equal to or lower than the predetermined voltage (or determines the reduced-voltage abnormality). The monitoring apparatus 40 transmits the initialization signal to the arithmetic processing apparatus 30 via the communication line b when the power source IC 41 included in the monitoring apparatus 40 determines the reduced-voltage abnormality. The arithmetic processing part 31 included in the arithmetic processing apparatus 30 receives the initialization signal via the communication line b and initializes the behavior of itself.

(Control for Determining Abnormality in a Predetermined Element)

The control for determining the abnormality in a predetermined element means a control under which the monitoring apparatus 40 monitors (determines) an abnormality in the predetermined elements. When determining the occurrence of the abnormality in a predetermined element, the monitoring apparatus 40 causes the arithmetic processing apparatus 30 to perform the fail-safe control and the abnormality record control, as mentioned above, by transmitting the pulse signal of the duty cycle corresponding to the abnormality in a predetermined element via the communication line c.

(Control for Transmitting Abnormality Notice Signal)

The control for transmitting the abnormality notice signal means a control under which the monitoring apparatus 40 generates a pulse signal of a duty cycle corresponding to the abnormality type determined, and transmits the pulse signal to the arithmetic processing part 31 via the communication line c. When determining that plural abnormalities have occurred substantially simultaneously, the monitoring apparatus 40 generates the pulse signal of the duty cycle representing an abnormality having a higher priority and transmits the pulse signal to the arithmetic processing apparatus 30 via the communication line c.

The priority is established as shown in FIG. 3. The abnormality in a predetermined element, of which notification is required most, is set as the first priority. The reduced-voltage abnormality is set as the second priority, the runaway process abnormality is set as the third priority, and the state of no-abnormality having the least necessity for notification is set as the fourth priority.

When determining the abnormality in a predetermined element and the reduced-voltage abnormality substantially simultaneously, the monitoring apparatus 40 transmits the pulse signal of the duty cycle representing the abnormality in a predetermined element, based on the priority established, in priority to the reduced-voltage abnormality, to the arithmetic processing apparatus 30 via the communication line c. This means that the monitoring apparatus 40 implements the control for transmitting the abnormality notice signal in accordance with the priority of notification to the arithmetic processing apparatus 30.

When determining an occurrence of the runaway process abnormality or the reduced-voltage abnormality in the arithmetic processing part 31, the monitoring apparatus 40 can transmit the initialization signal to the arithmetic processing apparatus 30 via the communication line b that is different from the communication line c, to initialize the arithmetic processing apparatus 30 (to cause the fail-safe control). However, the fail-safe control for the abnormality in a predetermined element is implemented after the abnormality is identified based on the pulse signal received from the communication line c. Therefore, the abnormality in a predetermined element has a higher priority of notification than the other abnormalities.

(Sequence 1 in a Case of Occurrence of Reduced-Voltage Abnormality)

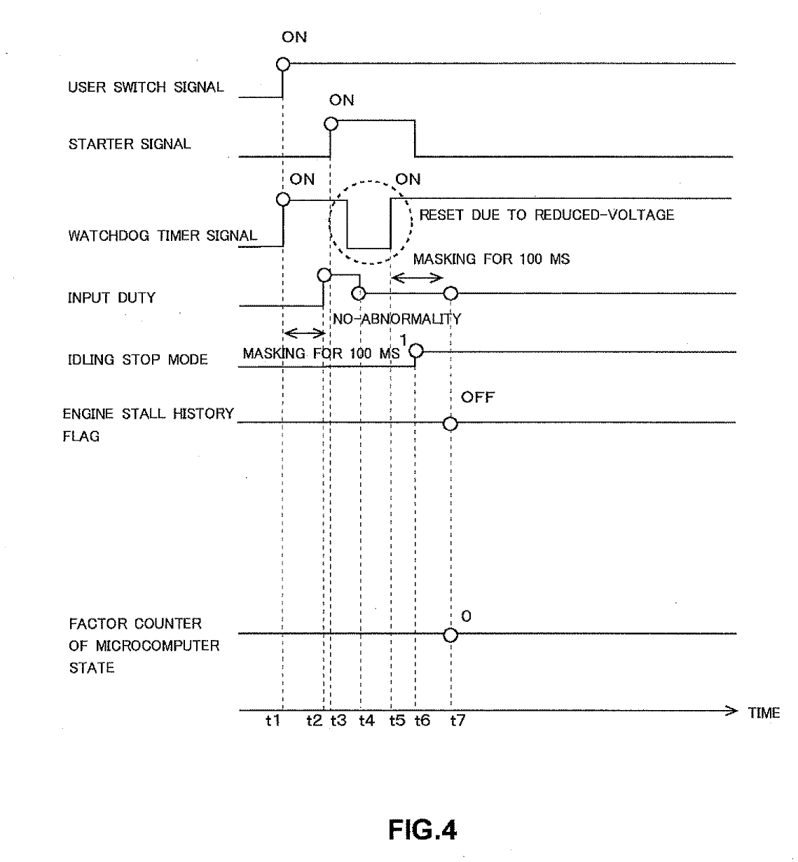

FIG. 4 shows a control sequence in a case where the reduced-voltage abnormality occurs when the idling stop control apparatus 1 performs an initial start of an engine of the vehicle 25. The twit “an initial start of an engine” refers to that the engine starts for the first time after the user operates the user switch.

When a user operates the user switch at t1 on a time axis, a user switch signal is turned on. Then, the power is supplied to the in-vehicle control system from the power source 60, the arithmetic processing part 31 included in the idling stop control apparatus 1 is activated and the arithmetic processing part 31 transmits the watchdog timer signal. With the power supply, the monitoring apparatus 40 is also activated. The arithmetic processing part 31 is incapable of performing various functions for a predetermined time (e.g., 100 ms) after being activated. Therefore, during the time period, the arithmetic processing apparatus 30 prohibits identification of an abnormality based on the pulse signal received via the communication line c (masking).

After the predetermined time passes, the arithmetic processing part 31 implements the identification of an abnormality at t2 on the time axis, based on the pulse signal received via the communication line c, and determines that there is no abnormality because the pulse signal received is in the pattern A.

The arithmetic processing part 31 turns on a signal for driving the starter motor 11 at t3 on the time axis, and keeps the signal turned on until the arithmetic processing part 31 determines, based on a signal received from the engine revolution sensor 12, that the engine achieves self ignition. In other words, the arithmetic processing part 31 performs the cranking control.

At t3 or at a later time point on the time axis, because the reduced-voltage abnormality occurred in the power supplied to the arithmetic processing part 31, the power source IC 41 included in the monitoring apparatus 40 determines the reduced-voltage abnormality and transmits the initialization signal to the arithmetic processing part 31 via the communication line b. One of possible reasons why the reduced-voltage abnormality occurs at this timing is that the power was supplied to the starter motor 11 that runs to start the engine under a condition of reduced electric charge of the power source 60 (a battery included in the vehicle 25) reduced. In other words, if the power is supplied to control a part, a control apparatus, an element, etc. other than the arithmetic processing part 31 in such a status, the voltage of the power supplied to the arithmetic processing part 31 is reduced. As a result, the behavior of the arithmetic processing part 31 becomes unstable. Therefore, the arithmetic processing part 31 is initialized.

When determining the reduced-voltage abnormality at t4 on the time axis, the monitoring apparatus 40 transmits the pulse signal of the duty cycle representing the reduced-voltage abnormality to the arithmetic processing part 31 via the communication line c.

The arithmetic processing part 31 initializes the behavior of itself at t5 on the time axis, based on the initialization signal received from the monitoring apparatus 40 via the communication line b. The arithmetic processing part 31 outputs a normal watchdog timer signal by initializing the behavior of itself.

Since the engine starts, the arithmetic processing part 31 changes an idling stop mode of the volatile memory part 33 to a mode 1 at t6 on the time axis. Here, the term “idling stop mode” refers a state where the idling stop function can be performed. The mode 1 of the idling stop mode refers to a state where the engine is revolving with the idling stop function performable (hereinafter referred to as an engine rotating state). A mode 2 of the idling stop mode refers to a state where the engine is demanded to stop with the idling stop function performable (hereinafter referred to as an engine stop demand state). A mode 3 of the idling stop mode refers to a state where the engine is stopping with the idling stop function performable (hereinafter referred to as an engine stopping state). A mode 4 of the idling stop mode refers to a state where the engine restarted after a stop of the engine with the idling stop function performable. The initial value of the idling stop mode is zero.

The arithmetic processing part 31 does not advance the factor counter of the reduced-voltage abnormality, in the first nonvolatile memory part 50 to count the abnormality, at t7 on the time axis. The factor counter of the reduced-voltage abnormality counts the occurrence of the reduced-voltage abnormality in the state where the idling stop function is being performed. Only when the idling stop mode is in one of the modes 2, 3, and 4, the idling stop function is regarded as being performed. The idling stop function is not regarded as being performed in this case having the mode 1. Therefore, the abnormality is not counted.

(Sequence 2 in a Case of Occurrence of Reduced-Voltage Abnormality)

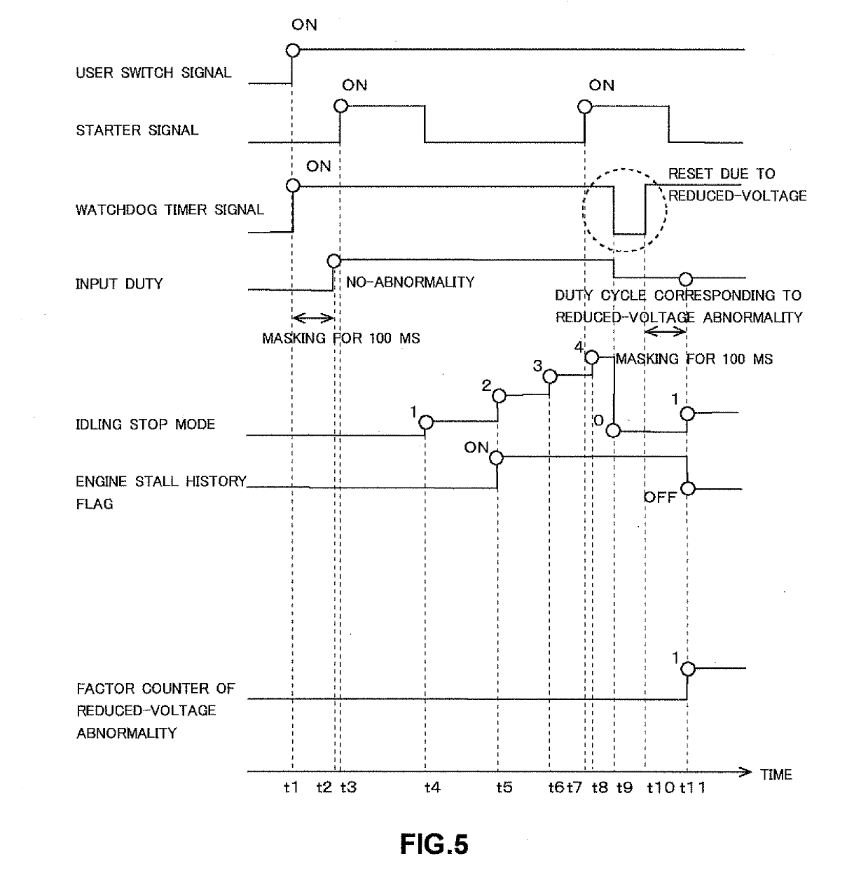

FIG. 5 shows a control sequence in a case where the reduced-voltage abnormality occurs while the idling stop control apparatus 1 performing the idling stop function starts the engine of the vehicle 25.

When the user operates the user switch at t1 on a time axis, the user switch signal is turned on. Then, the power is supplied to the in-vehicle control system from the power source 60, the arithmetic processing part 31 included in the idling stop control apparatus 1 is activated and the arithmetic processing part 31 transmits the watchdog timer signal. With the power supply, the monitoring apparatus 40 is also activated. The arithmetic processing part 31 is incapable of performing the various functions for the predetermined time (e.g., 100 ms) after being activated. Therefore, during the time period, the arithmetic processing apparatus 30 prohibits identification of an abnormality based on the pulse signal received via the communication line c (masking).

After the predetermined time passes, the arithmetic processing part 31 implements the identification of an abnormality at t2 on the time axis, based on the pulse signal received via the communication line c, and determines that there is no abnormality, because the pulse signal received is in the pattern A.

The arithmetic processing part 31 turns on the signal for driving the starter motor 11 at t3 on the time axis, and keeps the signal turned on until the arithmetic processing part 31 determines, based on the signal received from the engine revolution sensor 12, that the engine achieves self ignition. In other words, the arithmetic processing part 31 performs the cranking control.

Since the engine starts, the arithmetic processing part 31 changes the idling stop mode of the volatile memory part 33 to the mode 1 representing the engine rotating state, at t4 on the time axis. The initial value of the idling stop mode is zero.

Since a condition, such as vehicle speed at zero, is satisfied, at t5 on the time axis, the arithmetic processing part 31 outputs a demand signal for stopping the engine to the engine control apparatus 2 and changes the idling stop mode of the volatile memory part 33 to the mode 2 representing the engine stop demand state.

Moreover, the arithmetic processing apparatus 30 turns on an idling stop history flag of the third nonvolatile memory part 32 at t5 on the time axis. The flag is designed to determine whether the idling stop control apparatus 1 is performing the idling stop function, and the flag is turned on at the same time when the idling stop mode is changed to the mode 2. The arithmetic processing apparatus 30 is incapable of discriminating an engine state in the mode 1 from a state that the engine is normally revolving. Therefore, the arithmetic processing apparatus 30 does not turn on the history flag in the mode 1, and turns on the history flag when the idling stop mode is changed to the mode 2.

After outputting the demand signal for stopping the engine to the engine control apparatus 2 at t5 on the time axis, the arithmetic processing part 3 ldeterminesa stop of the engine, based on a signal received from the engine revolution sensor 12, and changes the idling stop mode of the volatile memory part 33 to the mode 3 representing the engine stopping state, at t6 on the time axis.

At t7 on the time axis, the arithmetic processing part 31 receives signals representing that the user pedaled the accelerator with turning off the brake, under a state that a gear shift range is at drive range. The arithmetic processing part 31 determines that there was a user demand to start engine by receiving the signals, and turns on a starter signal to start the engine.

At the same time when the engine starts, the arithmetic processing part 31 changes the idling stop mode, at t8 on the time axis, to the mode 4 representing a state where the engine restarted after a stop of the engine.

At t8 or at a later time point on the time axis, because the reduced-voltage abnormality occurred in the power supplied to the arithmetic processing part 31, the power source IC 41 included in the monitoring apparatus 40 determines the reduced-voltage abnormality and transmits the initialization signal to the arithmetic processing apparatus 30 via the communication line b. One of possible reasons why the reduced-voltage abnormality occurs at this timing is that the power was supplied to the starter motor 11 that runs to start the engine under a condition of reduced electric charge of the power source 60 (a battery included in the vehicle 25) of the power source 60 (the battery included in the vehicle 25) reduced. In other words, if the power is supplied to control a part, a control apparatus, an element, etc other than the arithmetic processing part 31 in such a status, the voltage of the power supplied to the arithmetic processing part 31 is reduced. As a result, the behavior of the arithmetic processing part 31 becomes unstable and the arithmetic processing part 31 is initialized.

The arithmetic processing part 31 initializes the behavior of itself at t9 on the time axis, based on the initialization signal received from the monitoring apparatus 40 via the communication line b. The arithmetic processing part 31 outputs the normal watchdog timer signal by initializing the behavior of itself. Moreover, with initializing the behavior of itself, the arithmetic processing part 31 also initializes the parameter stored in the volatile memory part 33. In other words, the arithmetic processing part 31 changes the idling stop mode stored in the volatile memory part 33 to the initial value zero.

When determining the occurrence of the reduced-voltage abnormality, the monitoring apparatus 40 transmits, at t9 on the time axis, the pulse signal of the duty cycle representing the reduced-voltage abnormality to the arithmetic processing part 31 via the communication line c.

Since the reduced-voltage abnormality is eliminated at t10 on the time axis, the arithmetic processing part 31 outputs the normal watchdog timer signal.

After a predetermined time (e.g., 10 ms) passes from t10 on the time axis at which the reduced-voltage abnormality is eliminated, the arithmetic processing part 31 implements the identification of an abnormality. The arithmetic processing part 31 is incapable of performing the various functions for the predetermined time (e.g., 100 ms) after being activated. Therefore, during the time period, the arithmetic processing part 31 prohibits the identification of an abnormality based on the pulse signal received via the communication line c (masking).

After the predetermined time passes, the arithmetic processing part 31 implements the identification of an abnormality at t11 on the time axis, based on the pulse signal received via the communication line c, and determines that the reduced-voltage abnormality occurred under a status that the idling stop function is performed by the arithmetic processing part 31, because the arithmetic processing part 31 received the pulse signal in a pattern other than the pattern A and the pattern B, the idling stop mode of the volatile memory part 33 indicates the initial value zero, and the idling stop history flag of the third nonvolatile memory part 32 is on. Thus, the arithmetic processing part 31 advances the factor counter of the reduced-voltage abnormality in the first nonvolatile memory part 50. A nonvolatile memory part is suitable for setting the factor counter of the reduced-voltage abnormality. The factor counter of the reduced-voltage abnormality may be set, e.g., in the third nonvolatile memory part 32.

The sequence described above allows to record the factor of the engine stall of the vehicle 25 in the idling stop mode, into a nonvolatile memory part.

(Sequence 3 in a Case of Occurrence of Runaway Process Abnormality)

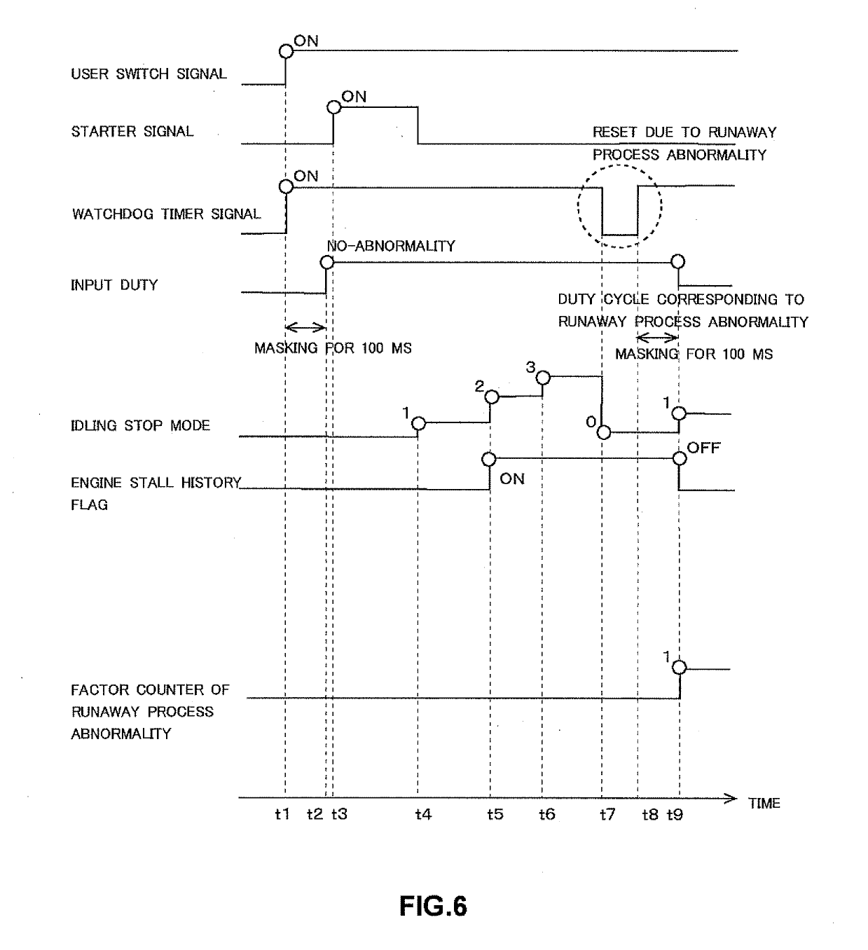

FIG. 6 shows a control sequence in a case where the runaway process abnormality occurred while the idling stop control apparatus 1 performing the idling stop function starts the engine of the vehicle 25.

When the user operates the user switch at t1 on the time axis, the user switch signal is turned on. Then, the power is supplied to the in-vehicle control system from the power source 60, the arithmetic processing part 31 included in the idling stop control apparatus 1 is activated and the arithmetic processing part 31 transmits the watchdog timer signal. With the power supply, the monitoring apparatus 40 is also activated. The arithmetic processing part 31 is incapable of performing the various functions of the arithmetic processing part 31 for the predetermined time (e.g., 100 ms) after being activated. Therefore, during the time period, the arithmetic processing part 31 prohibits identification of an abnormality based on the pulse signal received via the communication line c (masking).

After the predetermined time passes, the arithmetic processing part 31 implements the identification of an abnormality at t2 on the time axis, based on the pulse signal received via the communication line c, and determines that there is no abnormality, because the pulse signal received is in the pattern A.

The arithmetic processing part 31 turns on the signal for driving the starter motor 11 at t3 on the time axis, and keeps the signal turned on until the arithmetic processing part 31 determines, based on the signal received from the engine revolution sensor 12, that the engine achieves self ignition. In other words, the arithmetic processing part 31 performs the cranking control.

Since the engine starts, the arithmetic processing part 31 changes the idling stop mode of the volatile memory part 33 to the mode 1 representing the engine rotating state, at t4 on the time axis. The initial value of the idling stop mode is zero.

Since a condition, such as vehicle speed at zero, is satisfied, at t5 on the time axis, the arithmetic processing part 31 outputs the demand signal for stopping the engine to the engine control apparatus 2 and changes the idling stop mode of the volatile memory part 33 to the mode 2 representing the engine stop demand state.

Moreover, the arithmetic processing apparatus 30 turns on the idling stop history flag of the third nonvolatile memory part 32 at t5 on the time axis. The flag is designed to determine whether the idling stop control apparatus 1 is performing the idling stop function, and the flag is turned on at the same time when the idling stop mode is changed to the mode 2. The arithmetic processing apparatus 30 is incapable of discriminating the engine state on the mode 1 from the state that the engine is normally rotating. Therefore, the arithmetic processing apparatus 30 does not turn on the history flag in the mode 1, and turns on the history flag when the idling stop mode is changed to the mode 2.

After outputting the demand signal for stopping the engine to the engine control apparatus 2 at t5 on the time axis, the arithmetic processing part 31 determines a stop of the engine, based on a signal received from the engine revolution sensor 12, and changes the idling stop mode of the volatile memory part 33 to the mode 3 representing the engine stopping state at t6 on the time axis.

The monitoring apparatus 40 determines, at t7 on the time axis, that the runaway process abnormality occurred, because the watchdog timer signal received from the arithmetic processing part 31 via the communication line d is not a pulse signal which has the predetermined cycle. When determining the occurrence of the runaway process abnormality, the monitoring apparatus 40 transmits the initialization signal to the arithmetic processing part 31 via the communication line b. After receiving the initialization signal via the communication line b, the arithmetic processing part 31 initializes the behavior of itself. The arithmetic processing part 31 outputs the normal watchdog timer signal by initializing the behavior of itself. With initializing the behavior of itself, the arithmetic processing part 31 also initializes the parameter stored in the volatile memory part 33. In other words, the arithmetic processing part 31 changes the idling stop mode stored in the volatile memory part 33 to the initial value zero.

After determining the occurrence of the runaway process abnormality, the monitoring apparatus 40 transmits to the arithmetic processing part 31 the pulse signal of the duty cycle corresponding to the runaway process abnormality via the communication line c, at t8 on the time axis. Then, the arithmetic processing part 31 outputs the watchdog timer signal because the runaway process abnormality is eliminated.

After the predetermined time (e.g., 10 ms) passes from t8 on the time axis at which the runaway process abnormality is eliminated, the arithmetic processing part 31 implements the identification of an abnormality. The arithmetic processing part 31 is incapable of performing the various functions for the predetermined time (e.g., 100 ms) after being activated. Therefore, during the time period, the arithmetic processing part 31 prohibits the identification of an abnormality based on the pulse signal received via the communication line c (masking).

After the predetermined time passes, the arithmetic processing part 31 implements the identification of an abnormality at the t9 on the time axis, based on the pulse signal received via the communication line c, and determines that the runaway process abnormality occurred under a status that the idling stop function is performed by the arithmetic processing part 31, because the arithmetic processing part 31 receives the pulse signal in the pattern B, the idling stop mode of the volatile memory part 33 indicates the initial value zero, and the idling stop history flag of the third nonvolatile memory part 32 is on. Thus, the arithmetic processing part 31 advances the factor counter of the runaway process abnormality in the first nonvolatile memory part 50. A nonvolatile memory part is suitable for setting the factor counter of the runaway process abnormality. The factor counter of the runaway process abnormality may be set, e.g., in the third nonvolatile memory part 32.

The sequence described above allows to record the factor of the engine stall of the vehicle 25 in the idling stop mode, into a nonvolatile memory part.

(Sequence 4 in a Case of Simultaneous Occurrences of Reduced-Voltage Abnormality and Abnormality in a Predetermined Element)

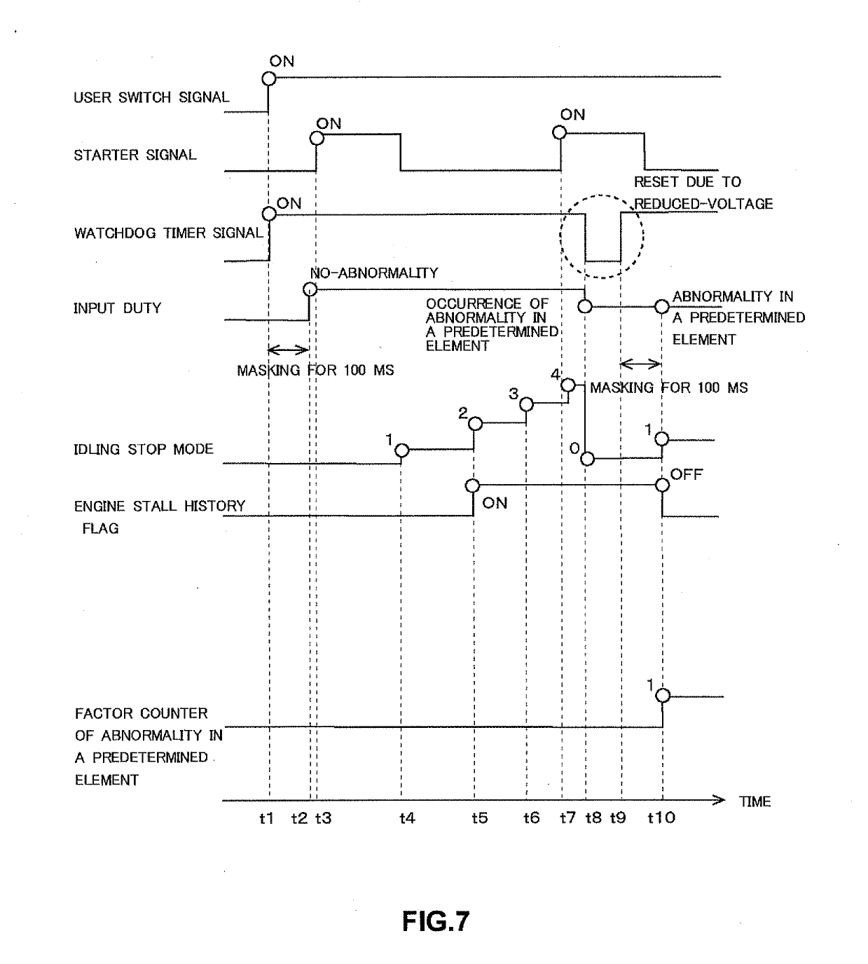

FIG. 7 shows a control sequence in a case where the reduced-voltage abnormality substantially simultaneously occurs with the abnormality in a predetermined element while the idling stop control apparatus 1 performing the idling stop function starts the engine of the vehicle 25. Here, the term, an abnormality occurs substantially simultaneously with another abnormality, refers to that an occurrence of an abnormality is determined within a predetermined time (e.g., 5 ms) after an occurrence of another abnormality is determined.

When the user operates the user switch at t1 on a time axis, the user switch signal is turned on. Then, the power is supplied to the in-vehicle control system from the power source 60, the arithmetic processing part 31 included in the idling stop control apparatus 1 is activated and the arithmetic processing part 31 transmits the watchdog timer signal. With the power supply, the monitoring apparatus 40 is also activated. The arithmetic processing part 31 is incapable of performing the various functions for the predetermined time (e.g., 100 ms) after being activated. Therefore, during the time period, the arithmetic processing part 31 prohibits identification of an abnormality based on the pulse signal received via the communication line c (masking).

After the predetermined time passes, the arithmetic processing part 31 implements the identification of an abnormality, at t2 on the time axis, based on the pulse signal received via the communication line c, and determines that there is no abnormality because the pulse signal received is in the pattern A.

The arithmetic processing part 31 turns on the signal for driving the starter motor 11 at t3 on the time axis, and keeps the signal turned on until the arithmetic processing part 31 determines, based on the signal received from the engine revolution sensor 12, that the engine achieves self ignition. In other words, the arithmetic processing part 31 performs the cranking control.

Since the engine starts, the arithmetic processing part 31 changes the idling stop mode of the volatile memory part 33 to the mode 1 representing the engine rotating state, at t4 on the time axis. The initial value of the idling stop mode is zero.

Since a condition, such as vehicle speed at zero, is satisfied, the arithmetic processing part 31 outputs, at t5 on the time axis, the demand signal for stopping the engine to the engine control apparatus 2 and changes the idling stop mode of the volatile memory part 33 to the mode 2 representing the engine stop demand state.

Moreover, the arithmetic processing apparatus 30 turns on the idling stop history flag of the third nonvolatile memory part 32 at t5 on the time axis. The flag is designed to determine whether the idling stop control apparatus 1 is performing the idling stop function, and the flag is turned on at the same time when the idling stop mode is changed to the mode 2. The mode 1 of the idling stop mode represents the engine rotating state. The arithmetic processing apparatus 30 is incapable of discriminating the engine state in the mode 1 from the state that the engine is normally rotating. Therefore, the arithmetic processing apparatus 30 does not turn on the history flag in the mode 1, and turns on the history flag when the idling stop mode is changed to the mode 2.

After outputting the demand signal for stopping the engine to the engine control apparatus 2 at t5 on the time axis, the arithmetic processing part 31 determines a stop of the engine, based on a signal received from the engine revolution sensor 12, and changes the idling stop mode of the volatile memory part 33 to the mode 3 representing the engine stopping state at t6 on the time axis.

At t7 on the time axis, the arithmetic processing part 31 receives signals representing that the user pedaled the accelerator with turning off the brake, under a state that a gear shift range is at drive range. The arithmetic processing part 31 determines that there was a user demand to start engine by receiving the signals, and turns on a starter signal to start the engine.

At the same time when the engine starts, the arithmetic processing part 31 changes, at t8 on the time axis, the idling stop mode in the volatile memory part 33, to the mode 4 representing the state where the engine restarted after a stop of the engine.

At t8 or at a later time point on the time axis, the reduced-voltage abnormality occurs in the power supplied to the arithmetic processing part 31. The power source IC 41 included in the monitoring apparatus 40 determines the occurrence of the reduced-voltage abnormality and transmits the initialization signal to the arithmetic processing part 31 via the communication line b. One of possible reasons why the reduced-voltage abnormality occurs at this timing is that the power was supplied to the starter motor 11 that runs to start the engine under a condition of reduced electric charge of the power source 60 (a battery included in the vehicle 25). In other words, if the power is supplied to control a part, a control apparatus, an element, etc other than the arithmetic processing part 31 in such a status, the voltage of the power supplied to the arithmetic processing part 31 is reduced. As a result, the behavior of the arithmetic processing part 31 becomes unstable and the arithmetic processing part 31 requires to be initialized.

Since the abnormality in a predetermined element also occurred concurrently, the monitoring apparatus 40 identifies the occurrence of the abnormality in a predetermined element and transmits to the arithmetic processing part 31 via the communication line c the pulse signal of the duty cycle representing the abnormality in a predetermined element, at t8 on the time axis.

The arithmetic processing part 31 initializes the behavior of itself at t9 on the time axis, based on the initialization signal received from the monitoring apparatus 40 via the communication line b. The arithmetic processing part 31 outputs the normal watchdog timer signal by initializing the behavior of itself. With initializing the behavior of itself, the arithmetic processing part 31 also initializes the parameter stored in the volatile memory part 33. In other words, the arithmetic processing part 31 changes the idling stop mode stored in the volatile memory part 33 to the initial value zero.

After determining the occurrence of the reduced-voltage abnormality substantially simultaneously with the occurrence of the abnormality in a predetermined element, the monitoring apparatus 40 transmits to the arithmetic processing part 31 the pulse signal of the duty cycle corresponding to the abnormality in a predetermined element via the communication line c, at t9 on the time axis. In other words, the monitoring apparatus 40 notifies the arithmetic processing part 31 of the abnormality in a predetermined element having a higher priority level, in priority to the reduced-voltage abnormality.

Since the reduced-voltage abnormality is eliminated, the arithmetic processing part 31 outputs the watchdog timer signal at t9 on the time axis.

After the predetermined time (e.g., 10 ms) passes from t9 on the time axis at which the reduced-voltage abnormality is eliminated, the arithmetic processing part 31 implements the identification of an abnormality. The arithmetic processing part 31 is incapable of performing the various functions for the predetermined time (e.g., 100 ms) after the arithmetic processing part 31 is activated. Therefore, during the time period, the arithmetic processing part 31 prohibits the identification of an abnormality based on the pulse signal received via the communication line c (masking).

After the predetermined time passes, the arithmetic processing part 31 implements the identification of an abnormality at t10 on the time axis, based on the pulse signal received via the communication line c. The arithmetic processing part 31 normality determines that the reduced-voltage abnormality occurred during the idling stop function performed by the arithmetic processing part 31, because the arithmetic processing part 31 receives the pulse signal in one of the pattern C, pattern D and the pattern E representing the abnormality in one of the predetermined element, the idling stop mode of the volatile memory part 33 indicates the initial value zero, and the idling stop history flag of the third nonvolatile memory part 32 is on. At the same time, the arithmetic processing part 31 determines that the abnormality in a predetermined element occurred in the predetermined element indicated by the pulse signal of the duty cycle corresponding to the pattern C, the pattern D, or the pattern E. In this case, the monitoring apparatus 40 transmits to the arithmetic processing part 31 the pulse signal of the duty cycle representing the abnormality in a predetermined element, as a priority abnormality. Therefore, if the runaway process abnormality is the abnormality that occurred, the pulse signal of the duty cycle in the pattern B representing the runaway process abnormality is sacrificed. In other words, it is not possible to identify under such conditions that a factor in initialization of the arithmetic processing part 31 is the runaway process abnormality or the reduced-voltage abnormality.

Therefore, the arithmetic processing part 31 prohibits the arithmetic processing part 31 from determining the reduced-voltage abnormality, to prevent a misidentification.

Moreover, the arithmetic processing part 31 advances the factor counter of the abnormality in a predetermined element set in the first nonvolatile memory part 50, but does not advance the factor counters of the runaway process abnormality and of the reduced-voltage abnormality. A nonvolatile memory part is suitable for setting the factor counter of the reduced-voltage abnormality. The factor counter of the reduced-voltage abnormality may be set, e.g., in the third nonvolatile memory part 32.

The sequence described above allows recording of the factor of the engine stall of the vehicle 25 in the idling stop mode, into a nonvolatile memory part, and allows not to record wrong information caused by misidentification.

(Sequence 5 in a Case of Simultaneous Occurrences of Runaway Process Abnormality and Abnormality in a Predetermined Element)

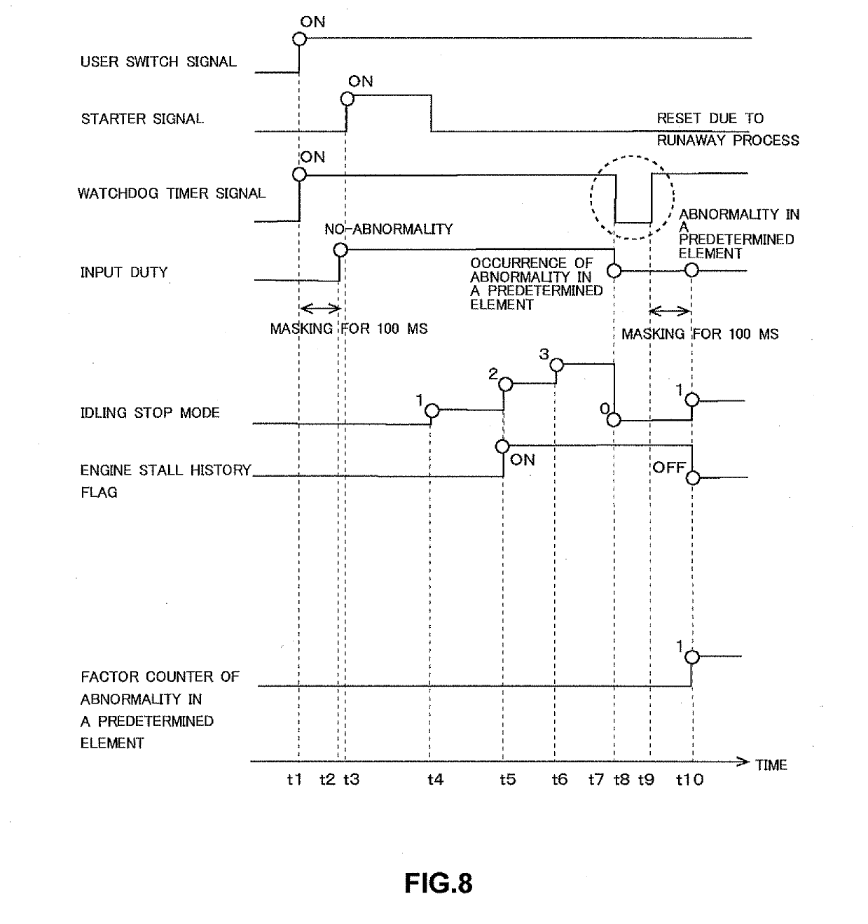

FIG. 8 shows a control sequence in a case where the runaway process abnormality occurs substantially simultaneously with the abnormality in a predetermined element while the idling stop control apparatus 1 performing the idling stop function starts the engine of the vehicle 25.

When the user operates the user switch at t1 on a time axis, the user switch signal is turned on. Then, the power is supplied to the in-vehicle control system from the power source 60, the arithmetic processing part 31 included in the idling stop control apparatus 1 is activated and the arithmetic processing part 31 transmits the watchdog timer signal. With the power supply, the monitoring apparatus 40 is also activated. The arithmetic processing part 31 is incapable of performing the various functions for the predetermined time (e.g., 100 ms) after being activated. Therefore, during the time period, the arithmetic processing part 31 prohibits the identification of an abnormality based on the pulse signal received via the communication line c (masking).

After the predetermined time passes, the arithmetic processing part 31 implements the identification of an abnormality at t2 on the time axis, based on the pulse signal received via the communication line c, and determines that there is no abnormality, because the pulse signal received is in the pattern A.

The arithmetic processing part 31 turns on the signal for driving the starter motor 11 at t3 on the time axis, and keeps the signal turned on until the arithmetic processing part 31 determines, based on the signal received from the engine revolution sensor 12, that the engine achieves self ignition. In other words, the arithmetic processing part 31 performs the cranking control.

Since the engine starts, the arithmetic processing part 31 changes the idling stop mode of the volatile memory part 33 to the mode 1 representing the engine rotating state, at t4 on the time axis. The initial value of the idling stop mode is zero.

Since a condition, such as vehicle speed at zero, is satisfied, at t5 on the time axis, the arithmetic processing part 31 outputs the demand signal for stopping the engine to the engine control apparatus 2 and changes the idling stop mode of the volatile memory part 33 to the mode 2 representing the engine stop demand state.

Moreover, the arithmetic processing apparatus 30 turns on the idling stop history flag of the third nonvolatile memory part 32 at t5 on the time axis. The flag is designed to determine whether the idling stop control apparatus 1 is performing the idling stop function, and the flag is turned on at the same time when the idling stop mode is changed to the mode 2. The mode 1 of the idling stop mode represents the engine rotating state. The arithmetic processing apparatus 30 is incapable of discriminating the engine state in the mode 1 from the state that the engine is normally rotating. Therefore, the arithmetic processing apparatus 30 does not turn on the history flag in the mode 1, and turns on the history flag when the idling stop mode is changed to the mode 2.

After outputting the demand signal for stopping the engine to the engine control apparatus 2 at t5 on the time axis, the arithmetic processing part 31 determines a stop of the engine, based on a signal received from the engine revolution sensor 12, and changes the idling stop mode of the volatile memory part 33 to the mode 3 representing the engine stopping state at t6 on the time axis.

Since the watchdog timer signal received from the arithmetic processing part 31 via the communication line d is not the pulse signal in the predetermined cycle, the monitoring apparatus 40 determines, at t7 on the time axis, that the runaway process abnormality occurred. When determining the occurrence of the runaway process abnormality in the arithmetic processing part 31, the monitoring apparatus 40 transmits the initialization signal to the arithmetic processing part 31 via the communication line b. After receiving the initialization signal via the communication line b, the arithmetic processing part 31 initializes the behavior of itself. The arithmetic processing part 31 outputs the normal watchdog timer signal by initializing the behavior of itself. With initializing the behavior of itself, the arithmetic processing part 31 also initializes the parameter stored in the volatile memory part 33. In other words, the arithmetic processing part 31 changes the idling stop mode stored in the volatile memory part 33 to the initial value zero.

When determining the runaway process abnormality, the monitoring apparatus 40 normally transmits to the arithmetic processing part 31 the pulse signal of the duty cycle corresponding to the runaway process abnormality via the communication line c, at t8 of the time axis. In this case, since determining the occurrence of the abnormality in a predetermined element substantially simultaneously with the runaway process abnormality, the monitoring apparatus 40 transmits to the arithmetic processing part 31 the pulse signal of the duty cycle corresponding to the abnormality in a predetermined element, via the communication line c. In other words, the monitoring apparatus 40 notifies, the arithmetic processing part 31 of the abnormality in a predetermined element having a higher priority, in priority to the runaway process abnormality.

The arithmetic processing part 31 outputs a normal watchdog timer signal at t9 on the time axis, because the runaway process abnormality is eliminated.

After the predetermined time (e.g., 10 ms) passes from t9 on the time axis at which the runaway process abnormality is eliminated, the arithmetic processing part 31 implements the identification of an abnormality. The arithmetic processing part 31 is incapable of performing the various functions for the predetermined time (e.g., 100 ms) after being activated. Therefore, during the time period, the arithmetic processing part 31 prohibits the identification of an abnormality based on the pulse signal received via the communication line c (masking).

After the predetermined time passes, the arithmetic processing part 31 implements the identification of an abnormality at t10 the on time axis, based on the pulse signal received via the communication line c. The arithmetic processing part 31 normally determines that the runaway process abnormality occurred under the idling stop function performed by the arithmetic processing part 31, because the arithmetic processing part 31 receives the pulse signal in one of the pattern C, pattern D and the pattern E representing the abnormality in one of the predetermined elements, the idling stop mode of the volatile memory part 33 indicates the initial value zero, and the idling stop history flag of the third nonvolatile memory part 32 is on. At the same time, the arithmetic processing part 31 determines that the abnormality in the predetermined element indicated by the pulse signal of duty cycle corresponding to the pattern C, the pattern D, or the pattern E. In this case, the monitoring apparatus 40 transmits to the arithmetic processing part 31 the pulse signal of the duty cycle representing the abnormality in a predetermined element, as a priority abnormality, at a sacrifice of the pulse signal of the duty cycle of the pattern B representing the runaway process abnormality. In other words, it is not possible to identify under such conditions that a factor in initialization of the arithmetic processing part 31 is the runaway process abnormality or the reduced-voltage abnormality.

Therefore, the arithmetic processing part 31 prohibits the arithmetic processing part 31 from determining the reduced-voltage abnormality, to prevent a misidentification.

Moreover, the arithmetic processing part 31 advances the factor counter of the abnormality in a predetermined element set in the first nonvolatile memory part 50, but does not advance the factor counters of the runaway process abnormality and the reduced-voltage abnormality. A nonvolatile memory part is suitable for setting the factor counter of the reduced-voltage abnormality. The factor counter of the reduced-voltage abnormality may be set, e.g., in the third nonvolatile memory part 32.

The sequence described above allows recording of the factor of the engine stall of the vehicle 25 in the idling stop mode, into a nonvolatile memory part, and allows not to record wrong information caused by misidentification.

(Sequence 6 in a Case of Occurrence of User Operation)

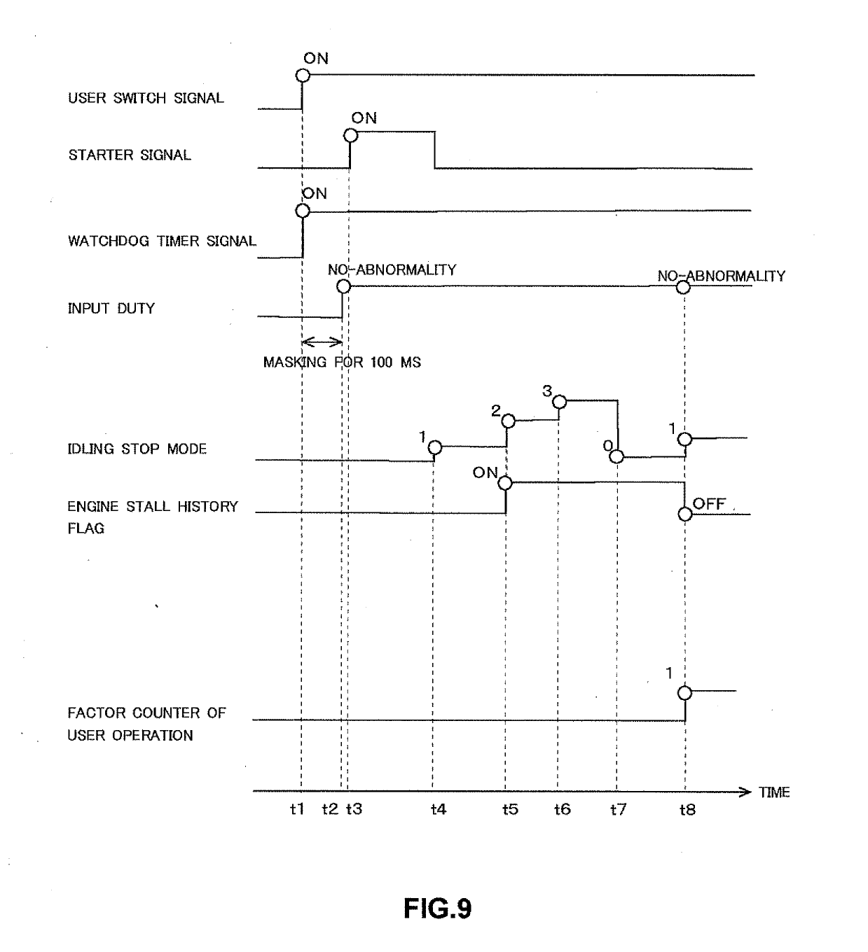

FIG. 9 shows a control sequence in a case where a predetermined user operation occurs while the idling stop control apparatus 1 performing the idling stop function starts the engine of the vehicle 25.

When the user operates the user switch at t1 on the time axis, the user switch signal is turned on. Then, the power is supplied to the in-vehicle control system from the power source 60, the arithmetic processing part 31 included in the idling stop control apparatus 1 is activated and the arithmetic processing part 31 transmits the watchdog timer signal. With the power supply, the monitoring apparatus 40 is also activated. The arithmetic processing part 31 is incapable of performing the various functions for the predetermined time (e.g., 100 ms) after being activated. Therefore, during the time period, the arithmetic processing part 31 prohibits the identification of an abnormality based on the pulse signal received via the communication line c (masking).

After the predetermined time passes, the arithmetic processing part 31 implements the identification of an abnormality at t2 on the time axis, based on the pulse signal received via the communication line c, and determines that there is no abnormality, because the pulse signal received is in the pattern A.

The arithmetic processing part 31 turns on the signal for driving the starter motor 11 at t3 on the time axis, and keeps the signal turned on until the arithmetic processing part 31 determines, based on the signal received from the engine revolution sensor 12, that the engine achieves self ignition. In other words, the arithmetic processing part 31 performs the cranking control.

Since the engine starts, the arithmetic processing part 31 changes the idling stop mode of the volatile memory part 33 to the mode 1 representing the engine rotating state, at t4 on the time axis. The initial value of the idling stop mode is zero.

Since a condition, such as vehicle speed at zero, is satisfied, at t5 on the time axis, the arithmetic processing part 31 outputs the demand signal for stopping the engine to the engine control apparatus 2 and changes the idling stop mode of the volatile memory part 33 to the mode 2 representing the engine stop demand state.

Moreover, the arithmetic processing apparatus 30 turns on the idling stop history flag of the third nonvolatile memory part 32 at t5 on the time axis. The flag is designed to determine whether the idling stop control apparatus 1 is performing the idling stop function, and the flag is turned on at the same time when the idling stop mode is changed to the mode 2. The mode 1 of the idling stop mode represents the engine rotating state. The arithmetic processing apparatus 30 is incapable of discriminating the engine state in the mode 1 from the state that the engine is normally revolving. Therefore, the arithmetic processing apparatus 30 does not turn on the history flag in the mode 1, and turns on the history flag when the idling stop mode is changed to the mode 2.

After outputting the demand signal for stopping the engine to the engine control apparatus 2 at t5 on the time axis, the arithmetic processing part 31 determines a stop of the engine, based on a signal received from the engine revolution sensor 12, and changes the idling stop mode of the volatile memory part 33 to the mode 3 representing the engine stopping state at t6 on the time axis.

Since receiving the hood switch-off signal via the in-vehicle network L, the arithmetic processing part 31 implements a control for stopping the idling stop function at t7 on the time axis. In other words, the arithmetic processing part 31 changes the idling stop mode of the volatile memory part 33 to the initial value zero and transmits the demand signal for stopping the engine to the engine control apparatus 2.

The arithmetic processing part 31 determines, at t8 on the time axis, that there is no abnormality, because the arithmetic processing part 31 receives the duty cycle of the pulse signal in the pattern A from the monitoring apparatus 40 via the communication line c. On the other hand, the arithmetic processing part 31 determines that the engine is stalled by a user operation during the idling stop function of the vehicle 25, because the idling stop history flag of the third nonvolatile memory part 32 is on and the arithmetic processing part 31 receives the hood switch-off signal.

Moreover, at t8 on the time axis, the arithmetic processing part 31 advances the factor counter of user operation set in the first nonvolatile memory part 50. A nonvolatile memory part is suitable for setting the factor counter of user operation. The factor counter of user operation may be set, e.g., in the third nonvolatile memory part 32.

The sequence described above allows recording of the factor of the engine stall of the vehicle 25 in the idling stop mode, into a nonvolatile memory part.

(Sequence 7 in a Case of Occurrences of User Operation and Abnormality in a Predetermined Element)

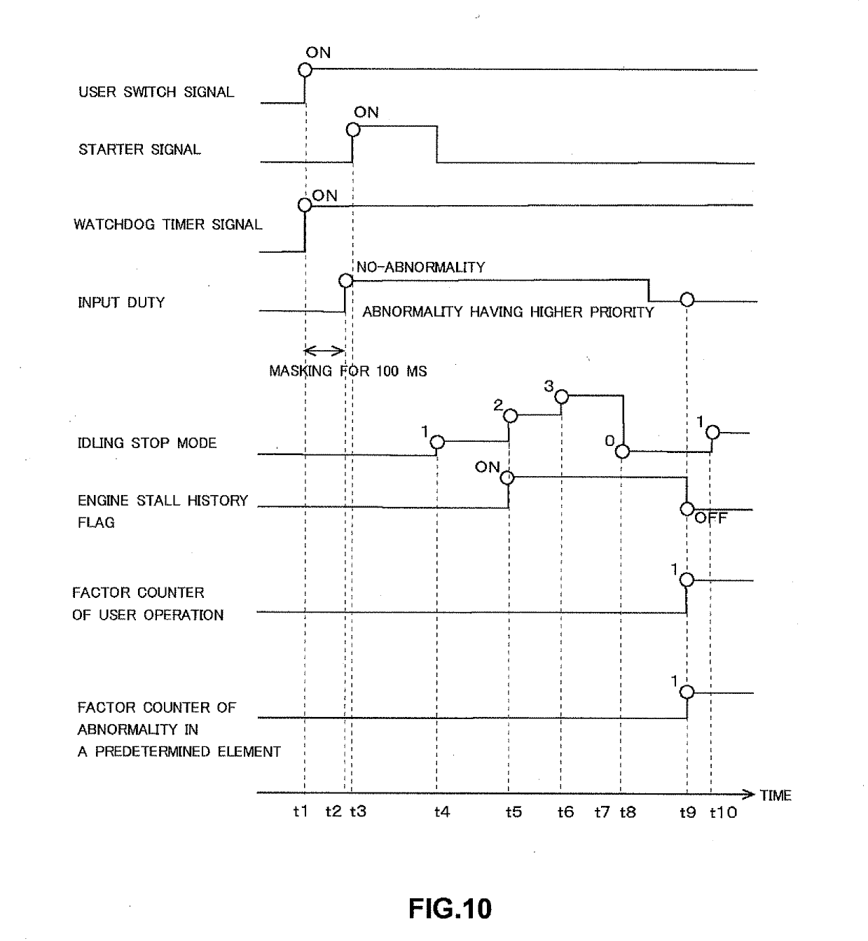

FIG. 10 shows a control sequence in a case where the predetermined user operation substantially simultaneously occurs with the abnormality in a predetermined element while the idling stop control apparatus 1 performing the idling stop function starts the engine of the vehicle 25.

When the user operates the user switch at t1 on a time axis, the user switch signal is turned on. Then, the power is supplied to the in-vehicle control system from the power source 60, the arithmetic processing apparatus 30 included in the idling stop control apparatus 1 is activated and the arithmetic processing part 31 transmits the watchdog timer signal. With the power supply, the monitoring apparatus 40 is also activated. The arithmetic processing part 31 is incapable of performing the various functions for the predetermined time (e.g., 100 ms) after the being activated. Therefore, during the time period, the arithmetic processing part 31 prohibits the identification of an abnormality based on the pulse signal received via the communication line c (masking).

After the predetermined time passes, the arithmetic processing part 31 implements the identification of an abnormality at t2 on the time axis, based on the pulse signal received via the communication line c, and determines that there is no abnormality because the pulse signal received is in the pattern A.

The arithmetic processing part 31 turns on the signal for driving the starter motor 11 at t3 on the time axis, and keeps the signal turned on until the arithmetic processing part 31 determines, based on the signal received from the engine revolution sensor 12, that the engine achieves self ignition. In other words, the arithmetic processing part 31 performs the cranking control.

Since the engine starts, the arithmetic processing part 31 changes the idling stop mode of the volatile memory part 33 to the mode 1 representing the engine rotating state, at t4 on the time axis. The initial value of the idling stop mode is zero.

Since a condition, such as vehicle speed at zero, is satisfied, at t5 on the time axis, the arithmetic processing part 31 outputs the demand signal for stopping the engine to the engine control apparatus 2 and changes the idling stop mode of the volatile memory part 33 to the mode 2 representing the engine stop demand state.

Moreover, the arithmetic processing apparatus 30 turns on the idling stop history flag of the third nonvolatile memory part 32 at t5 on the time axis. The flag is designed to determine whether the idling stop control apparatus 1 is performing the idling stop function, and the flag is turned on at the same time when the idling stop mode is changed to the mode 2. The arithmetic processing apparatus 30 is incapable of discriminating the engine state in the mode 1 from the state that the engine is normally revolving. Therefore, the arithmetic processing apparatus 30 does not turn on the history flag in the mode 1, and turns on the history flag when the idling stop mode is changed to the mode 2.

After outputting the demand signal for stopping the engine to the engine control apparatus 2 at t5 on the time axis, the arithmetic processing part 31 determines a stop of the engine, based on a signal received from the engine revolution sensor 12, and changes the idling stop mode of the volatile memory part 33 to the mode 3 representing the engine stopping state at t6 on the time axis.

Since receiving the hood switch-off signal via the in-vehicle network L, the arithmetic processing part 31 implements the control for stopping the idling stop function at t7 on the time axis. In other words, the arithmetic processing part 31 transmits the demand signal for stopping the engine to the engine control apparatus 2. Moreover, the arithmetic processing part 31 changes the idling stop mode of the volatile memory part 33 to the initial value zero.

The arithmetic processing part 31 determines the abnormality in a predetermined element at t8 on the time axis because the arithmetic processing part 31 receives the duty cycle of the pulse signal (in the pattern C, pattern D or the pattern E) representing the abnormality in a predetermined element from the monitoring apparatus 40 via the communication line c. On the other hand, the arithmetic processing part 31 determines that the engine is stalled by a user operation during the idling stop function of the vehicle 25, because the idling stop history flag of the third nonvolatile memory part 32 is on and the arithmetic processing part 31 receives the hood switch-off signal.

At t9 on the time axis, the arithmetic processing part 31 advances the factor counters of user operation and of the abnormality in a predetermined element being set in the first nonvolatile memory part 50. A nonvolatile memory part is suitable for setting the factor counter of user operation. The factor counter of user operation may be set, e.g., in the third nonvolatile memory part 32.

The sequence described above allows recording of the factor of the engine stall of the vehicle 25 in the idling stop mode, into a nonvolatile memory part.

### Modification

An embodiment of this invention was hereinbefore described. However, this invention is not limited to the embodiment described above, and various modifications can be implemented. The embodiment described above or a modification of the embodiment may be arbitrarily combined with one or more of other modifications.

### Modification Example 1

In the previous sections explaining the Sequence 6 in a case of occurrence of user operation and the Sequence 7 in a case of occurrences of user operation and abnormality in a predetermined element, it is explained that the control for stopping the idling stop function is implemented when the arithmetic processing part 31 receives the hood switch-off signal representing that the user opens the hood. However, as shown in FIG. 3, the control for stopping the idling stop function may be implemented when the arithmetic processing part 31 receives the user switch-off signal representing that the user ends the in-vehicle control system with the user switch.

Moreover, it is explained that, in order to record the abnormality content, the factor counters of the runaway process abnormality, of the reduced-voltage abnormality, of the abnormality in a predetermined element, and of user operation are set in the first nonvolatile memory part 50, and the arithmetic processing part 31 advances the factor counter corresponding to each of abnormalities at each time when the arithmetic processing part 31 identifies an abnormality. However, in addition to them, a factor counter of a user switch operation may be set in the first nonvolatile memory part 50, and the arithmetic processing part 31 may advance the factor counter of a user switch operation at each time when the arithmetic processing part 31 implements the control for stopping the idling stop function by receiving a signal representing that the user switch is operated.

### Modification Example 2

In the previous sections explaining the Sequence 6 in a case of occurrence of user operation and the Sequence 7 in a case of occurrences of user operation and abnormality in a predetermined element, it is explained that the control for stopping the idling stop function is implemented when the arithmetic processing part 31 receives the hood switch-off signal representing that the user opens the hood. However, the control for stopping the idling stop function may be implemented when the arithmetic processing part 31 receives a signal relating to the vehicle state, in other words, a demand for stopping of the idling stop function from one of the other in-vehicle control apparatuses (e.g., the battery control apparatus 3 and the transmission control apparatus 4), not the signal of a user operation.

Moreover, it is explained that, in order to record the abnormality content, the factor counters of the runaway process abnormality, of the reduced-voltage abnormality, of the abnormality in a predetermined element, and of user operation are set in the first nonvolatile memory part 50, and the arithmetic processing part 31 advances the factor counter corresponding to each of abnormalities at each time when the arithmetic processing part 31 identifies an abnormality. However, in addition to them, a factor counter of stop demands, which counts demands to stop the idling stop control may be set in the first nonvolatile memory part 50, and the arithmetic processing part 31 may advance the factor counter of stop demand at each time when the control for stopping the idling stop function is implemented by receiving a signal representing the demand to stop the idling stop control.

### Modification Example 3

In the previous sections explaining the Sequence 6 in a case of occurrence of user operation and the Sequence 7 in a case of occurrences of user operation and abnormality in a predetermined element, it is explained that the control for stopping the idling stop function is implemented when the arithmetic processing part 31 receives the hood switch-off signal representing that the user opens the hood. However, the control for stopping the idling stop function may be implemented when the arithmetic processing part 31 receives the impact detection signal that is detected in a case where the vehicle 25 collides against an external object.

Moreover, it is explained that, in order to record the abnormality content, the factor counters of the runaway process abnormality, of the reduced-voltage abnormality, of the abnormality in a predetermined element, and of user operation are set in the first nonvolatile memory part 50, and the arithmetic processing part 31 advances the factor counter corresponding to each of abnormalities at each time when the arithmetic processing part 31 identifies an abnormality. However, in addition to them, a factor counter of impacts, which counts impacts on the vehicle 25, may be set in the first nonvolatile memory part 50, and the arithmetic processing part 31 may advance the factor counter of impacts at each time when the control for stopping the idling stop function is implemented after receiving the impact detection signal.

In the embodiment described above, various functions are implemented by software performance performed by arithmetic processing of a CPU in accordance with a program. However, a part of the functions may be implemented by an electrical hardware circuit. Contrarily, a part of functions implemented by a hardware circuit in the embodiment may be implemented by software performance.

While the invention has been shown and described in detail, the foregoing description is in all aspects illustrative and not restrictive. It is therefore understood that numerous other modifications and variations can be devised without departing from the scope of the invention.

What is claimed is:

1. An in-vehicle control apparatus for controlling a controlled object for installation in a vehicle, the in-vehicle control apparatus comprising:
a first controlling part that controls the controlled object by using data stored in a volatile memory part; and
a second controlling part that transmits an abnormality notice signal to the first controlling part when an abnormality occurs in the vehicle,
wherein the second controlling part includes:
a first determination part that determines an occurrence of a first abnormality relating to behavior of the first controlling part;
a second determination part that determines an occurrence of a second abnormality relating to electric power supplied to the first controlling part;
a third determination part that determines an occurrence of a third abnormality relating to a predetermined element included in the vehicle;
a transmission part that transmits an initialization signal for initializing the data stored in the volatile memory part to the first controlling part when one of the first abnormality and the second abnormality occurs; and
a communication part that transmits the abnormality notice signal having a waveform pattern that represents the type of an abnormality occurring to the first controlling part via a communication line, the communication part transmitting the abnormality notice signal representing the third abnormality to the first controlling part when the third abnormality occurs substantially simultaneously with an other abnormality,
wherein the first controlling part includes:
an identification part that identifies the type of the abnormality occurring on the basis of the abnormality notice signal;
a recording part that records the type of the abnormality identified on a nonvolatile recording apparatus; and
an identification prohibiting part that prohibits identification by the identification part when the abnormality notice signal represents the third abnormality and the data stored in the volatile memory part is initialized, and
wherein the identification part identifies:
the type of the abnormality occurring as the first abnormality when the abnormality notice signal represents the first abnormality and the data stored in the volatile memory part is initialized;
the type of the abnormality occurring as the second abnormality when the abnormality notice signal represents an abnormality other than the first abnormality and the data stored in the volatile memory part is initialized; and
the type of the abnormality occurring as the third abnormality when the abnormality notice signal represents the third abnormality.

2. The in-vehicle control apparatus according to claim 1, wherein
the controlled object is an engine, and
the first controlling part performs an idling stop control that stops the engine when a predetermined condition is satisfied.

3. The in-vehicle control apparatus according to claim 2, further comprising
a control prohibiting part that prohibits the idling stop control when the identification part identifies the type of the abnormality occurring as one of the first abnormality, the second abnormality and the third abnormality.

4. The in-vehicle control apparatus according to claim 3, further comprising
a notification part that notifies a user when the idling stop control is prohibited.

5. The in-vehicle control apparatus according to claim 2, wherein
the predetermined element is used for the idling stop control.

6. A control method for controlling a controlled object for installation in a vehicle, the method comprising the steps of:
(a) controlling the controlled object by using data stored in a volatile memory part by a first controlling part;
(b) transmitting an abnormality notice signal to the first controlling part by a second controlling part when an abnormality occurs in the vehicle; and
(c) recording the type of the abnormality occurring in the vehicle on a nonvolatile recording apparatus by the first controlling part,
wherein the step (b) includes the steps of:
(b1) determining an occurrence of a first abnormality relating to behavior of the first controlling part;
(b2) determining an occurrence of a second abnormality relating to electric power supplied to the first controlling part;
(b3) determining an occurrence of a third abnormality relating to a predetermined element included in the vehicle;
(b4) transmitting an initialization signal for initializing the data stored in the volatile memory part to the first controlling part when one of the first abnormality and the second abnormality occurs; and
(b5) transmitting the abnormality notice signal having a waveform pattern that represents the type of an abnormality occurring to the first controlling part via a communication line, in which the abnormality notice signal representing the third abnormality is transmitted to the first controlling part when the third abnormality occurs substantially simultaneously with the first abnormality,
wherein the step (c) includes the steps of:
(c1) identifying the type of the abnormality occurring on the basis of the abnormality notice signal;
(c2) recording the type of the abnormality occurring on the nonvolatile recording apparatus; and
(c3) prohibiting the identification in the step (c1) when the abnormality notice signal represents the third abnormality and the data stored in the volatile memory part is initialized, and
wherein the step (c1) includes the steps of:
(c11) identifying the type of the abnormality occurring as the first abnormality when the abnormality notice signal represents the first abnormality and the data stored in the volatile memory part is initialized;
(c12) identifying the type of the abnormality occurring as the second abnormality when the abnormality notice signal represents an abnormality other than the first abnormality and the data stored in the volatile memory part is initialized; and
(c13) identifying the type of the abnormality occurring as the third abnormality when the abnormality notice signal represents the third abnormality.

7. The control method according to claim 6, wherein
the controlled object is an engine, and
the first controlling part performs an idling stop control that stops the engine when a predetermined condition is satisfied.

8. The control method according to claim 7, further comprising the step of
(d) prohibiting the idling stop control when the type of the abnormality occurring is identified as one of the first abnormality, the second abnormality and the third abnormality in the step (c1).

9. The control method according to claim 8, further comprising the step of
(e) notifying a user when the idling stop control is prohibited.

10. The control method according to claim 7, wherein
the predetermined element is used for the idling stop control.
